(19) United States
(12) Patent Application Publication
(10) Pub. No.: US 2018/0301820 A1
(43) Pub. Date: Oct. 18, 2018

(54) WAVEGUIDE ELEMENTS, FABRICATION TECHNIQUES AND ARRANGEMENTS THEREOF

(71) Applicant: ISRAEL AEROSPACE INDUSTRIES LTD., Lod (IL)

(72) Inventors: Aviad BREGMAN, Petach Tikva (IL); Shahar SHAKED, Kiryat Ono (IL)

(21) Appl. No.: 15/766,931

(22) PCT Filed: Oct. 6, 2016
(86) PCT No.: PCT/IL16/51091

§ 371 Date: Apr. 9, 2018

(30) Foreign Application Priority Data
Oct. 7, 2015 (IL) 241951

(51) Int. Cl. H01Q 21/08; H01P 3/123; H01P 11/00; H01Q 13/10

(52) U.S. Cl. CPC H01Q 21/08; H01P 3/123; H01Q 21/0087; H01Q 13/10; H01P 11/002

(57) ABSTRACT

Waveguide elements, fabrication techniques, and arrangements thereof, are disclosed. The waveguide comprises in some embodiments an elongated hollow element having an elongated internal cavity and one or more electrically conducting layers plating at least internal walls of the elongated cavity. The elongated hollow element is implemented by a continuous unitary element made from a fibrous material impregnated with a resin material, thereby providing a lightweight unitary waveguide structure that substantially minimize, or preclude, leakage of electromagnetic energy along the waveguide length.

### TECHNOLOGICAL FIELD

The present invention is generally in the field of waveguides.

### BACKGROUND

The present disclosure relates generally to waveguide configurations, and particularly to slotted waveguide structures designed for waveguide antennas, and to methods of manufacture thereof. Waveguides are typically rectangular or circular tubing elements designed to carry electromagnetic waves from one point to another. Slotted waveguides are durable and relatively inexpensive to construct elements, which are used in applications requiring highly directional high-gain antenna elements (e.g., radar systems, microwave-communication systems).

Slotted waveguides are usually made from elongated electrically conducting rectangular tubing elements, having one or more radiators implemented by pass-through slots formed in at least one wall of the elongated rectangular tubing. The geometry and space between the radiators/slots of the waveguide are determined according to the operational wavelength of the waveguide. In use, radiation is emitted directly through the slots of the waveguides due to the interference they impose to the flow of electrical currents, that is required to circumvent the slots. The pattern of the radiation emitted through the slots is also a function of the shape of the waveguide and of its frequency of operation.

Some waveguide fabrication techniques known from the patent literature are briefly described below.

U.S. Pat. No. 5,495,262 describes a microwave radar antenna that substantially comprises molded or extruded thermoplastic components that are assembled into completed assemblies, are then metallized by either electroless copper or are electroplated with copper to achieve RF conductivity. The finished subassemblies are joined together forming the completed antenna. The molded, metallized, plastic antenna uses a thermoplastic material, such as polyetherimide, or suitable high strength, high temperature thermoplastic that is used to injection mold or extrude detailed microwave components. The molded components are assembled, using epoxy adhesives, solvents or other mechanical method into microwave subassemblies. These subassemblies are then either electroless copper plated or electroplated to provide RF conductivity. The metallized subassemblies are then joined together using mechanical methods to form a completed radar antenna, replacing heavier more costly metal radar antennas.

U.S. Pat. No. 5,398,010 describes a microwave assembly having molded thermoplastic components that are first assembled into an enclosure, and then electroless copper plated to provide for RF conductivity. Assemblies are made by bonding bare thermoplastic components, after which the bonded assembly is electroless copper plated. The components are made of an injection molding material, polyetherimide, or a high strength, high temperature thermoplastic. The components are assembled using a one component epoxy adhesive, for example. All components are designed to be self locating to aid in assembly. A bonding fixture is used to apply clamping pressure to the components while the adhesive cures. After bonding, the waveguide assembly has its critical flange surfaces finish machined prior to plating.

U.S. Pat. No. 5,380,386 describes a method of fabricating a microwave waveguide component wherein a plurality of joinable thermoplastic members are first formed. The members, when joined, comprise a microwave waveguide component having an internal surface that is adapted to be plated. The thermoplastic members are then bonded together. Then, the internal surface is plated to form the finished microwave waveguide component. This method forms microwave components from plated, injection molded thermoplastic and reaction injection molded thermosetting plastics.

In U.S. Pat. No. 5,579,020 a unitary waveguide element is employed in a light weight waveguide antenna. The waveguide element has a waveguide portion having a front wall with slots formed across it at predetermined locations, a continuous back wall, and substantially continuous broad walls. A first flange is formed on one of the broad walls lying in a plane that extends in the width direction. A pair of flanges are formed on the other broad wall that lie in planes that are displaced slightly from the first flange, so that when the waveguide element is superposed onto the next successive element, these flanges overlap with the second flanges straddling the first flange. The flanges are then bonded with epoxy or an equivalent agent. A rivet box is formed on the proximal side of the back wall and permits attachment of the waveguide element in precise alignment to a predrilled backing plate with rivets or other suitable fasteners. The rivets do not penetrate into the waveguide portion of the element.

### GENERAL DESCRIPTION

The present invention provides waveguide configurations, and manufacture techniques thereof, for fabrication of unitary (i.e., monolithic) lightweight waveguide antenna elements from composite materials. Conventionally, waveguide elements are assembled from metal components manufactured by metal mold casting or extrusion techniques, which are relatively complex and expensive, and results in substantially heavy weight waveguide elements. The present invention aims to provide techniques for manufacturing lightweight unitary waveguide body elements from composite and/or plastic materials that can be used to implement relatively inexpensive mass production processes. The unitary waveguide body elements of the present invention are used to implement waveguides that substantially minimize, or preclude, leakages of electromagnetic energy along their lengths.

In some embodiments the waveguide body elements are manufactured by a pultrusion process, suitable for mass production of unitary body elements having substantially uniform cross-sectional (e.g., circular or rectangular/polygon) shape along their lengths. In other possible embodiments the waveguide body elements are manufactured by applying one or more composite material layers (also referred to herein as composite lamination) over removable (e.g., deformable or sacrificial) core elements, formed/sculptured in accordance with a desired shape of the waveguide, which may comprise either substantially flat or curved surfaces, and combinations thereof.

In some applications the techniques disclosed herein are used to construct a planar array of slotted waveguides implementing an array antenna, wherein a plurality of unitary waveguide elements are assembled in a side-by-side (one parallel to the other) configuration to provide improved radiation patterns and enable electronic beam steering.

Conventional planar waveguide antenna arrays are typically assembled from two planar metal plates of substantially overlapping shapes, which face surfaces comprise structures and patterns designed to construct elongated waveguide elements by attaching one plate to the other. An alternative approach for construction of waveguide antenna arrays suggests successive superposing extruded metallic waveguide elements having slotted front walls, one onto the other, by bonding side flanges thereof. In these techniques, however, the waveguides are manufactured by metal mold casting, machining or extrusion processes, which are relatively expensive and complex, and yields heavy weight waveguide array structures.

There is thus a need in the art for waveguide configurations, and methods of manufacture thereof, which are suitable for easy, quick and cost effective, construction of substantially lightweight unitary waveguide elements from composite materials. The inventors of the present invention devised novel waveguide manufacture techniques suitable for manufacturing unitary waveguide elements from composite materials that permit efficient assembly of lightweight planar waveguide arrays, and substantially minimize or preclude electromagnetic energy leakages along their lengths. The waveguide elements disclosed herein are substantially lightweight and inexpensive to manufacture, relative to the conventional metal based implementations. In addition, embodiments of the waveguide arrays disclosed herein can be advantageously used to implement small-size portable radar antennas that can be easily carried by a person/operator and effectively operated in field conditions by infantry soldiers.

In some embodiments techniques are provided for quick and efficient manufacture of unitary waveguide body elements by pulling fibrous material through a heated curing die configured to impregnate the pulled fibrous material with a suitable resin, shape the pulled impregnated material to form elongated hollow tubing elements, and cure the shaped impregnated material as it is being pulled out of the die. This fabrication technique, referred to herein as a pultrusion process, enables fabrication of elongated unitary hollow lightweight tubing elements from composite materials, preferably epoxy based materials reinforced by carbon fibers or fiberglass.

The pultrusion process is thus configured to produce elongated unitary hollow profiles/bodies having an internal elongated cavity passing along their lengths, and having a substantially uniform cross-sectional shape along their lengths. In this way the entire body of each waveguide element is manufactured in a single pultrusion process, without requiring bonding/assembly of discrete waveguide components, thereby significantly minimizing/preventing leakage of electromagnetic energy from the waveguide element. The waveguide body elements then undergo a coating process (e.g., electroless plating) in which at least their elongated internal cavities are plated with one or more electrically conducting layers.

In some embodiments the pultrusion process is immediately followed by a machining/puncturing process in which radiator slots are formed in at least one wall of the pultruded waveguide body elements. Alternatively, the radiator slots may be formed in the waveguide body elements after applying the one or more electrically conducting layers.

In other possible embodiments, elongated unitary hollow lightweight body elements are manufactured by applying one or more composite material layers over a removable core element, curing the applied composite material layers, and removing the core elements from the cured elements. This technique enables manufacture of waveguide body elements having curved (e.g., circular or wavy) shapes. The waveguide body elements obtained after the core element is removed undergoes a coating process (e.g., electroless plating) in which at least their internal cavities are plated with one or more electrically conducting layers.

In some embodiments, at least one connector hole is formed (e.g., drilled) in one of the walls of the hollow waveguide body element for electromagnetically coupling it to a signal source/receiver. Optionally, and in some embodiments preferably, first and second connector holes are formed in each waveguide body element, for coupling electromagnetic input signals to the waveguide element, and for coupling electromagnetic output signals from the waveguide element, respectively. The connector holes can be formed at the extremities of the waveguide body element e.g., at a quarter-wave (λ/4) distances one from the other. In some embodiments, the radiator slots are formed along a single wall of the waveguide body element, and the connector holes are formed in another wall thereof, preferably in the opposite wall facing the wall in which the radiator slots are formed.

In some embodiments, the waveguide body elements are manufactured from a dielectric (i.e., having low or negligibly small electrical conductivity) material(s) such as, but not limited to, thermoplastic materials, epoxy based materials, and combinations thereof. After the elongated waveguide body elements are manufactured, one or more electrically conducting layers are applied over surface areas of the waveguide elements. The end openings of the waveguide body elements can be closed by covers configured to snugly fit therein.

The waveguides manufacture techniques disclosed herein can be advantageously used to construct planar arrays of waveguide elements for implementing waveguide antenna arrays. In some embodiments, two or more hollow (e.g., rectangular tubing) waveguide body elements are fabricated (concurrently or one at the time) by any of the manufacture techniques described hereinabove and hereinbelow Immediately thereafter, each hollow waveguide body element is introduced into a punching or fast machining system configured to form one or more radiator slots in one of the walls of the waveguide body element. In preferred embodiments a plurality of radiator slots are formed along a certain wall of the waveguide body elements. First and second connector holes are then formed in extremities of the opposite wall of the slotted waveguide body elements (i.e., in the wall facing the slotted wall), to provide electromagnetic coupling for input signals at one end of each element (i.e., input connector), and to provide electromagnetic coupling for output signals at its other end (i.e., output connector).

A planar array of slotted waveguide body elements is assembled in some embodiments by attaching the slotted waveguide body elements one to the other in a side-by-side configuration with predetermined distances between them (depending on the operating frequency of the array antenna), such that the slotted walls of the waveguide elements are substantially aligned in the same plane, their input connectors are substantially aligned at one lateral side of the array, and their output connectors are substantially aligned at the other/opposite lateral side of the array. The end openings of the slotted waveguide elements can be closed, before or after attaching them one to other, by covers designed to fit snugly thereinto.

Preferably, first and second elongated cover elements are used to close the end openings of the slotted waveguide elements after attaching them one to other, by attaching (e.g., by welding or bonding with a suitable adhesive material) the elongated covers along the two (opposite) lateral sides of the planar array structure encompassing the end openings of the slotted elements. The elongated cover elements thereby effectively seal the end openings of the waveguide elements of the planar array structure, and at the same time reinforce (e.g., by fitting protrusions) the planar array structure by maintaining the required predetermined distances between the waveguide elements and maintaining their slotted walls aligned in the same plane. Optionally, and in some embodiments preferably, the planar array structure is further reinforced by applying one or more composite material layers (e.g., made by composite lamination) over the slotted face of the array, so as to form (e.g., by an autoclaving process) a radome layer (i.e., protective layer that is electromagnetically transparent to the transmitted/received signals) over the slotted walls of the waveguide elements that bonds and connects the waveguide elements one to the other.

In some embodiments the covers of the end openings are at least partially covered by one or more electrically conducting layers before connecting them over the end openings of the slotted waveguide elements.

Optionally, and is some embodiments preferably, the waveguide body elements comprise mating attachment components at their elongated lateral sides configured for quickly connecting the waveguide body elements one to the other in a side-by-side configuration and maintain predetermined distances between them required for proper operation of the waveguide antenna array. In some embodiments the mating components are implemented by elongated male and female connectors formed along the lateral sides of the waveguide body elements. This configuration facilitates the constructions of antenna arrays comprising a plurality of waveguide elements connected to each other side-by-side, and guarantees that the waveguide elements are properly connected to each other such that their input connectors reside at one end of the array, their output connectors at the other side of the array, and that all the radiator slots are aligned in the same plane i.e., prevents wrong connection of the waveguide elements side faces.

For example, and without being limiting, the pultrusion process may be configured such that the waveguide profiles pulled through the pultrusion die integrally includes the mating components at their lateral sides. In this configuration, the pultruded waveguide body profiles comprise an upper elongated face configured to be processed for formation of the radiator slots therein, two lateral elongated side faces comprising the mating elements, and a bottom face comprising one or two connector holes Similarly, if composite lamination techniques are used, the composite lamination process may be configured to integrally include the mating components at the lateral sides of the waveguide profiles.

Thus an aspect of some embodiments of the present application relates to a waveguide comprising an elongated hollow body element having an elongated internal cavity (which may include an elongated rib on a bottom internal wall thereof), and one or more electrically conducting layers plating at least internal walls of said elongated cavity. The elongated hollow body element being a continuous unitary element made from a fibrous material impregnated with a resin material, so as to provide a lightweight unitary waveguide structure that substantially minimize or preclude leakage of electromagnetic energy along its length.

In some embodiments the waveguide comprises two pass-through connector bores each formed in a back face of the elongated hollow body element and located at a respective end portion thereof and configured for electromagnetic coupling with the waveguide. Optionally, and in some embodiments preferably, the elongated hollow body element comprises a plurality of radiator slots distributed along a front face thereof. In some applications, an elevated rim is formed about the front face of the elongated hollow element, thereby forming a cavity in which the radiator slots reside. The radiator slots may be distributed along the front face of the elongated hollow element so as to form a “>”-shaped pattern.

The waveguide further comprises in some embodiments two cover elements respectively attached over end openings of the elongated hollow body element. Each cover element may comprise one or more layers of electrically conducting material plated over at least a surface area thereof covering a respective end opening of the elongated hollow body element.

Optionally, and in some embodiments preferably, lateral side faces of the elongated hollow body element of the waveguide comprise connector elements, each connector element being configured to mate with a connector element of an elongated hollow body element of another waveguide and thereby enable successively connecting two or more waveguides one parallel to the other, while maintaining a predetermined distance between them and substantially aligning the radiator slots in their front faces in the same plane. For example, the connector elements comprise an elongated male connector provided on one lateral side face of the elongated hollow element and a complementary elongated female connector element provided on its other lateral side face. The elongated male connector element may have a tapering configuration and the elongated female connector may have a complementary flaring configuration.

In some embodiments the elongated hollow body element of the waveguide is manufactured by pulling fibrous material through a heated curing die configured to impregnate the pulled fibrous material with a suitable resin. Alternatively, the elongated hollow body element is manufactured by layering one or more composite material layers over a deformable or a sacrificial core element. The core element may have substantially flat or curved surface areas, or combinations thereof.

Another aspect of embodiments of the present application relates to a waveguide array comprising two or more of the waveguides elements described hereinabove or hereinbelow successively attached to each other at their lateral sides. In this case, the covering elements are preferably two elongated elements, each configured to cover end openings at lateral sides of the waveguide array and substantially attach and align the extremities of the two or more waveguides of the array. Optionally, and in some embodiments preferably, the waveguide array comprises one or more reinforcing layers covering the front faces of the waveguides. For example, the one or more reinforcing layers are protective layers configured to form a radome over a radiator plane of the array.

Another aspect of embodiments of the present application relates to a waveguide antenna comprising a planar array of two or more elongated hollow elements attached one to the other in parallel in a side-by-side configuration, each elongated hollow element being a continuous unitary element made from a composite material and having an elongated internal cavity. Optionally, and in some embodiments preferably, each elongated hollow element comprises one or more electrically conducting layers plated over at least internal walls of its elongated internal cavity. A plurality of pass-through slots may be distributed along a front face of each elongated hollow element. In a variant, two pass-through connector bores are provided in each elongated hollow elements, where each pass-through connector bore is provided in a bottom face of the elongated hollow element and located at a respective end portion of the bottom face and configured for electromagnetic coupling therewith.

Optionally, and in some embodiment preferably, the waveguide antenna comprises two elongated cover elements, each attached over one lateral side of the array for substantially closing end openings of the two or more elongated hollow element of the array. The cover elements are configured to substantially attach extremities of the two or more elongated hollow elements one to the other and align the pass-through slots in their front faces in the same plane. Lateral side faces of the elongated hollow elements may comprise connector elements, each connector element being configured to mate and connect with a connector element of a successive elongated hollow element in the array, maintain a predetermined distance therebetween, and substantially align the pass-through slots in the front faces of the elongated hollow element in the same plane.

The waveguide antenna may comprise one or more reinforcing layers applied over the front faces of the two or more elongated hollow elements and configured to attach said elongated hollow elements to each other and maintain a predetermined distance between them.

Another aspect of embodiments of the present application relates to a waveguide production process comprising forming an elongated continuous unitary hollow element from a fibrous material by impregnating the fibrous material with a resin material and forming a predetermined waveguide shape therefrom, and plating at least inner walls of said elongated hollow element by electrically conducting material, thereby obtaining a lightweight unitary waveguide structure that substantially minimize or preclude electromagnetic energy leakage along its length.

In some embodiments, the forming of the predetermined waveguide shape comprises pulling the fibrous material through a heated curing die configured to impregnate the pulled fibrous material with the resin material.

Alternatively, the forming of the predetermined waveguide shape comprises shaping a deformable core element in accordance with the predetermined shape of the waveguide, applying one or more layers of the fibrous and resin materials over the deformable core element, curing the one or more layers applied over the core element, and deforming the core element and extracting the one or more cured layers therefrom. The shaping of the deformable core may comprise heating the core elements to change said core element into a softened state, molding the core element to provide the predetermined waveguide shape, and cooling the core element to change the core element into a rigid state.

The forming of the predetermined waveguide shape comprises in some embodiments preparing a sacrificial core (e.g., by a three-dimensional printer) element in accordance with the predetermined shape of the waveguide, applying one or more layers of the fibrous and resin materials over the deformable core element, curing the one or more layers applied over the core element, and removing the sacrificial core element from the one or more cured layers. The removing of the sacrificial core element comprises at least one of vaporizing, liquefying, and dissolving, said core element. In this way, the core element is structured to comprise substantially flat or curved surface areas, or combinations thereof.

The production process may comprise forming in end portions of a bottom face of said elongated hollow element two pass-through connector bores. A plurality of pass-through slots may be also formed along a front face of the elongated hollow element. The production process may comprise forming cover elements and closing end openings of the elongated hollow element by said cover elements. The forming of the cover elements may comprise applying one or more electrically conducting layers over surface areas of the cover elements. Connector elements may be formed in lateral sides of the elongated hollow element, each connector element being configured to mate with a connector element of an elongated hollow element of another waveguide and thereby enable successively connecting two or more of the waveguides one parallel to the other, while maintaining a predetermined distance between them and substantially aligning their front faces in the same plane.

Another aspect of embodiments of the present application relates to a process of fabricating a waveguide antenna, the process comprising producing two or more of the waveguide elements as described hereinabove or hereinbelow and attaching them one to the other in parallel to form a planar array. Two elongated cover elements are used for closing the end openings of the waveguide elements by attaching one cover element over each lateral side of the array for closing the end openings therein and attaching the extremities thereof. One or more reinforcing layers may be applied over the front faces of the elongated hollow elements to thereby attached them to each other and maintain a predetermined distance between them.

### BRIEF DESCRIPTION OF THE DRAWINGS

In order to understand the invention and to see how it may be carried out in practice, embodiments will now be described, by way of non-limiting example only, with reference to the accompanying drawings. Features shown in the drawings are meant to be illustrative of only some embodiments of the invention, unless otherwise implicitly indicated. In the drawings like reference numerals are used to indicate corresponding parts, and in which:

FIG. 1 schematically illustrates a waveguide body element according to some possible embodiments;

FIG. 2 is a sectional view of a slotted waveguide antenna element according to some possible embodiments;

FIG. 3 shows a top perspective view of a slotted waveguide element according to some possible embodiments;

FIG. 4 shows a perspective view of a bottom side of a slotted waveguide element according to some possible embodiments;

FIG. 5 is a perspective view showing a perspective view of a bottom side of a slotted waveguide element, and structure of its covers, according to some possible embodiments;

FIG. 6 schematically illustrates a planar waveguide array according to some possible embodiments;

FIGS. 7A to 7D show waveguide arrays, according to possible embodiments, attached by mating attachment components to form a planar array structure, wherein FIG. 7A shows a perspective view of a waveguide array comprising three waveguide elements, FIG. 7B shows a perspective view of an elongated cover sheet of the array, FIG. 7C shows a perspective cross-sectional view of the waveguide array of FIG. 7A, and FIG. 7D shows a cross-sectional view of a waveguide array comprising two waveguide elements; and

FIGS. 8A to 8C are flowcharts of waveguide antenna production processes according to some possible embodiments, wherein FIG. 8A illustrates production of hollow waveguide elements by pultrusion, FIG. 8B illustrates productions of hollow waveguide elements using a deformable core, and FIG. 8C illustrates production of hollow waveguide elements using a sacrificial core.

### DETAILED DESCRIPTION OF EMBODIMENTS

One or more specific embodiments of the present disclosure will be described below with reference to the drawings, which are to be considered in all aspects as illustrative only and not restrictive in any manner In an effort to provide a concise description of these embodiments, not all features of an actual implementation are described in the specification. Elements illustrated in the drawings are not necessarily to scale, emphasis instead being placed upon clearly illustrating the principles of the invention. This invention may be provided in other specific forms and embodiments without departing from the essential characteristics described herein.

The present invention provides various manufacture techniques for fabricating lightweight (e.g., 200 to 250 grams, optionally about 206 to 210 grams) unitary hollow waveguide body elements from composite materials. More particularly, the present invention provides techniques for manufacturing lightweight hollow unitary waveguide elements by composite lamination and pultrusion processes designed to substantially simplify the production process of the waveguide elements. The composite lamination techniques described herein utilizes in some embodiments a deformable or sacrificial core for the constructions of hollow waveguide body elements, and in the pultrusion techniques hollow waveguide body elements are constructed by pulling fibrous material (e.g., Carbon fibers, fiberglass) impregnated with a suitable resin (e.g., epoxy) through a heated die in a single pultrusion process. The waveguide manufacture techniques disclosed herein are further utilized for construction of lightweight planar arrays of waveguide elements, which are usable for implementing portable antennas that can be easily carried and operated by a user.

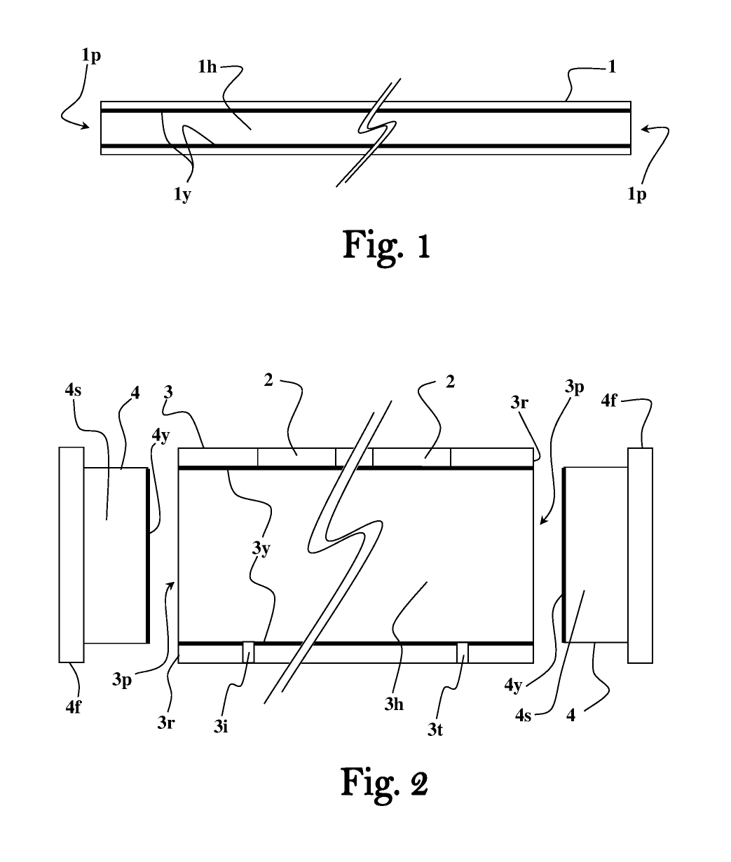

FIG. 1 is a sectional view of a hollow unitary waveguide element 1 according to some possible embodiments. The body of the waveguide element 1 is preferably fabricated from an epoxy based material by a single pultrusion process i.e., by pulling fibrous material impregnated with epoxy resin through a pultrusion die, or by composite lamination techniques, configured to produce elongated hollow profiles. After curing the elongated hollow tubing element, one or more electrically conducting layers 1y are applied at least over inner walls of its internal elongated cavity 1h. In this way an elongated waveguide element 1 is obtained having two end openings 1p, one of which is used for inputting electromagnetic waves into the waveguide elements 1, and the other for outputting the electromagnetic waves propagating therealong.

FIG. 2 shows a sectional view of a slotted waveguide element 3 according to some possible embodiments. The slotted waveguide element 3 is made from an elongated hollow tubing, having one or more electrically conducting layers 3y, fabricated substantially similar to the fabrication of waveguide element 1 described hereinabove with reference to FIG. 1. A plurality of pass-through slots 2 are formed (e.g., by fast machining) in the front face of the waveguide element 2 for radiating electromagnetic radiation therethrough during operational use, and two pass-through connector bores 3i and 3t are formed in its bottom face for electromagnetic coupling with the waveguide.

Two cover elements 4 are used to seal the end openings 3p the slotted waveguide element 2. In this specific example, each cover element 4 comprises a sealing portion 4s, configured and operable to snugly fit into the end opening 3p and seal it, and a flange portion 4f configured to abut and cover the external rim 3r to the opening 3p. Optionally, and in some embodiments preferably, one or more electrically conducting layers 4y are applied over the front face of the sealing portions 4s of the cover elements 4.

The electrically conducting layers 3y of the waveguide element, and/or 4y of the cover elements 4, are applied in some embodiments by an electroless plating process used for depositing a substantially uniform layer of Copper or Silver having thickness of about 3 micrometer. In some embodiments the electrically conducting layers 3y of the waveguide element, and/or 4y of the cover elements 4, are gold layers having thickness of about 4 micrometer. Alternatively, in possible embodiments, the electrically conducting layers 3y of the waveguide element, and/or 4y of the cover elements 4, comprise at least one layer of Copper having thickness of about 4 micrometer, and at least one layer of Nickel having thickness of about 0.1 micrometer.

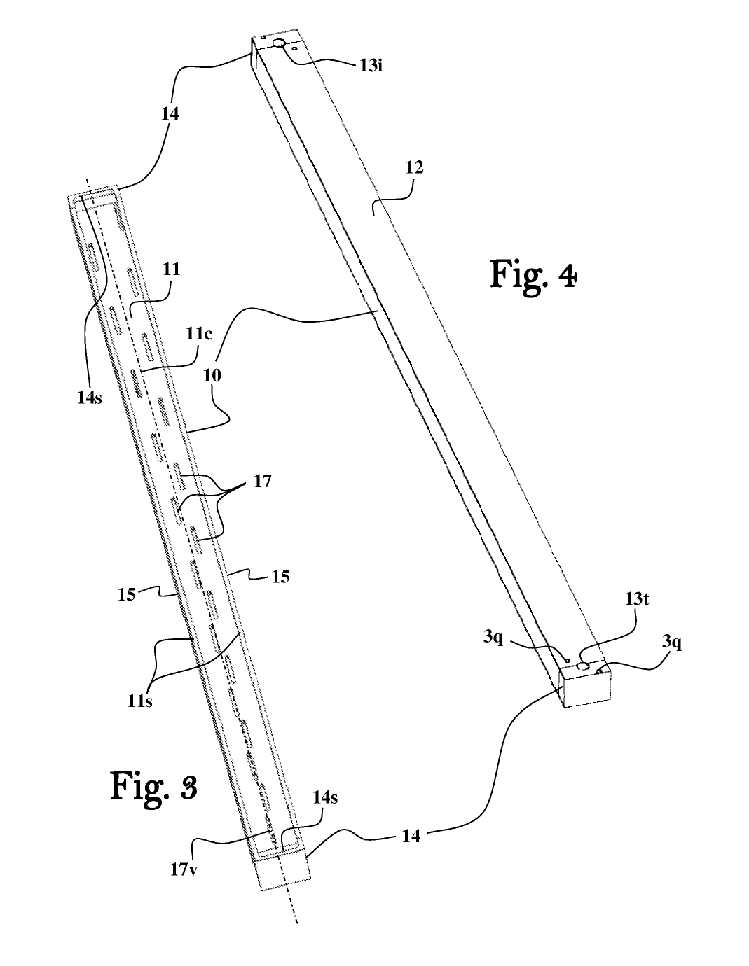

FIG. 3 shows a top perspective view of a slotted waveguide 10 according to some possible embodiments. The waveguide 10 in this non-limiting example is a hollow elongated rectangular element having a one or more pass-through slots 17 formed along its upper side 11. The slots 17 are oriented substantially parallel to the long axis (11c) of the waveguide 10. In this non-limiting example the slots 17 are formed along the length of the upper face 11 forming a tapering “>”-shaped pattern. This tapering pattern is obtained by forming the vertex slot 17v substantially on the center line 11e (at the center of the width) of the upper face 11, and alternatively diverting the location of each subsequent slot 17 formed therein in a progressively increasing distance above and below the center line 11e of the upper face 11.

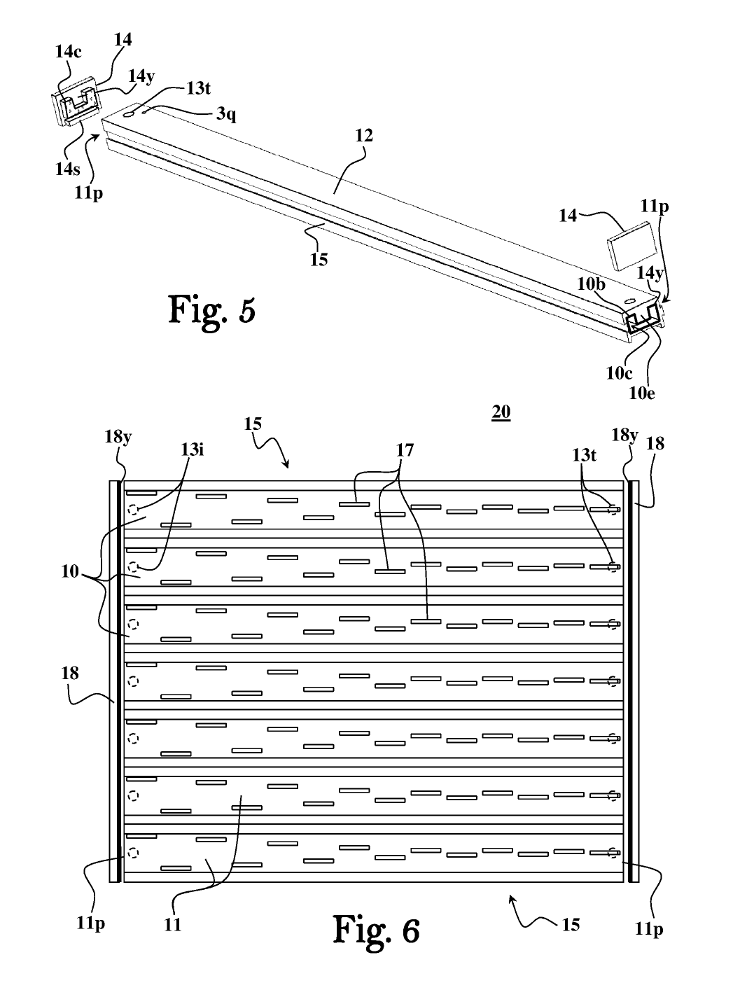

In this example, end openings (11p in FIG. 5) of the waveguide element 10 are shown closed by fitting covers 14. The lateral sides 15 of the waveguide element 10, and its covers 14, are configured to form an elevated rim 11s enclosing the upper face 11 and forming a shallow upper cavity in which the radiators slots 17 are located.

FIG. 4 shows a perspective view of the bottom side 12 of the waveguide element 10. The bottom side 12 of the waveguide element 10 comprises two connector pass-through bores, 13i and 13t (collectivity referred to herein as connector bores 13), drilled at extremities thereof, near the end openings of the waveguide element 10. The connector bores, 13i and 13t, are each configured to receive a male conductor of a connector (not shown) adapted to pass all the way therethrough and into the hollow interior of the waveguide element 10. Two fastening bores are provided in the proximity of each of the connector bores 13 for fastening the connector to the bottom face 12 of the waveguide element 10.

The connector bores 13 are configured to separately electromagnetically couple the waveguide element 10 to receive input signals and deliver output signals. In this non-limiting example the connector bores 13 are formed (e.g., by milling each element or by drilling) at the interfaces between the ends of the waveguide element 10 and their respective covers 14.

FIG. 5 is a perspective view showing a bottom side of the waveguide element 10 according to some possible embodiments, without the covers 14. As seen, the waveguide element 10 comprises an elongated cavity 10c passing therealong. In this non limiting example the bottom face 10b of the elongated cavity 10c comprises an elongated rib 10e passing along its length and facing the slotted upper face for implementing a loading ridge. However, in possible embodiments such loading ridge is not required and thus may be removed from the waveguide design. FIG. 5 further shows a perspective view of the covers 14 used in possible embodiments for closing the end openings 11p of the waveguide element 10.

The covers 14 in this non-limiting example comprise fitting protrusions 14c and 14s designed to snugly fit and attach the covers 14 to the end openings 11p. For example, the “U”-shaped protrusion 14c is designed to fit into the cavity 10c and embrace end portions of the elongated rib 10e, and the protrusion 14s formed in each of the covers 14 is designed to snugly fit between the elevated rims 11s of the waveguide element 10.

In preferred embodiments the entire body structure of the waveguide element 10 is manufactured from a composite material by pultrusion or by composite lamination process. The waveguide element 10 may be prepared from materials having good electrical conductivity (e.g., comprising electrically conducting metals, conductive polymer composites, or combinations thereof). However, in order to minimize costs and weight of the waveguide elements, the use of certain types of dielectric materials (e.g., epoxy based composites) was found to be preferable. In case the waveguide element is made from material(s) of poor electrical conductivity, one or more layers 14y of electrically conducting materials (e.g., Copper, Silver, Gold, Nickel, or combinations thereof) are applied (e.g., electroless plating) over selected (or the entire) surface areas of the waveguide element 10 e.g., over the inner surfaces of its elongated cavity 10c (including the elongated rib 10e). Optionally, and in some embodiments preferably, selected surface areas of the covers 14, such as the “U”-shaped protrusion 14c, are also coated with one or more electrically conducting layers 14y (e.g., electroless plating).

In this way, substantially lightweight and inexpensive unitary waveguide elements 10 can be easily and quickly manufactured. For example, and without being limiting, in some embodiments the length of the waveguide element 10 is up to one meter. After applying the electrically conducting layer(s), the weight of the waveguide element 10 obtained with this configuration is about 200 to 250 grams.

FIG. 6 schematically illustrates a planar waveguide array 20 according to some possible embodiments. The waveguide array 20 is constructed by attaching two or more slotted waveguides 10 in a side-by-side configuration by attaching (e.g., by welding or by bonding with any suitable adhesive material) lateral sides 15 of adjacently located waveguide body elements 10. In this planar array configuration 20 the upper sides 11 encompassing the radiator slots 17 are substantially aligned in the same plane (in the front face of the array), and a predetermined distance between the elements is maintained. Similarly, the connector bores 13 of the waveguide body elements 10 are substantially aligned in another plane (in the back face of the array), being substantially parallel to the plane of the radiator slots 17.

As also seen, the input connector bores 13i of the waveguide body elements 10 are substantially aligned at one side of the array 20, and the output connector bores 13t are aligned at the other side of the array 20. This array configuration thus provides that the patterns of the slots 17 are oriented in the same direction.

The waveguide body elements 10 of array 20 may be manufactured by pultrusion or composite lamination, as described hereinabove and hereinbelow, from electrically conducting materials, or from dielectric materials. In some embodiments the waveguide body elements 10 are manufactured by pultrusion or composite lamination of lightweight dielectric materials (e.g., fiber reinforced polymers or plastics), and the slotted waveguide elements 10 are then plated by one or more layers of electrically conducting material(s) thereover.

As seen in FIG. 6, the end openings 11p of the waveguide body elements 10 are closed by two elongated cover sheets 18. Each elongated cover sheet 18 is attached over a lateral side of the array 20 so as to close and seal all end openings 11p therein. The elongated cover sheet 18 may be manufactured from electrically conducting material, or from dielectric materials, using any suitable production technique. In some embodiments the elongated cover sheets 18 are manufactured from a dielectric material to which one or more layers 18y of electrically conducting material(s) are applied. As seen, the one or more electrically conducting material layers 18y may be applied only over the sides of the elongated cover sheets 18 that cover the end openings 11p of the waveguide elements 10. In this configuration, the elongated cover sheets 18 are attached over the end openings 11p of the waveguide body elements 10 by any suitable adhesive material.

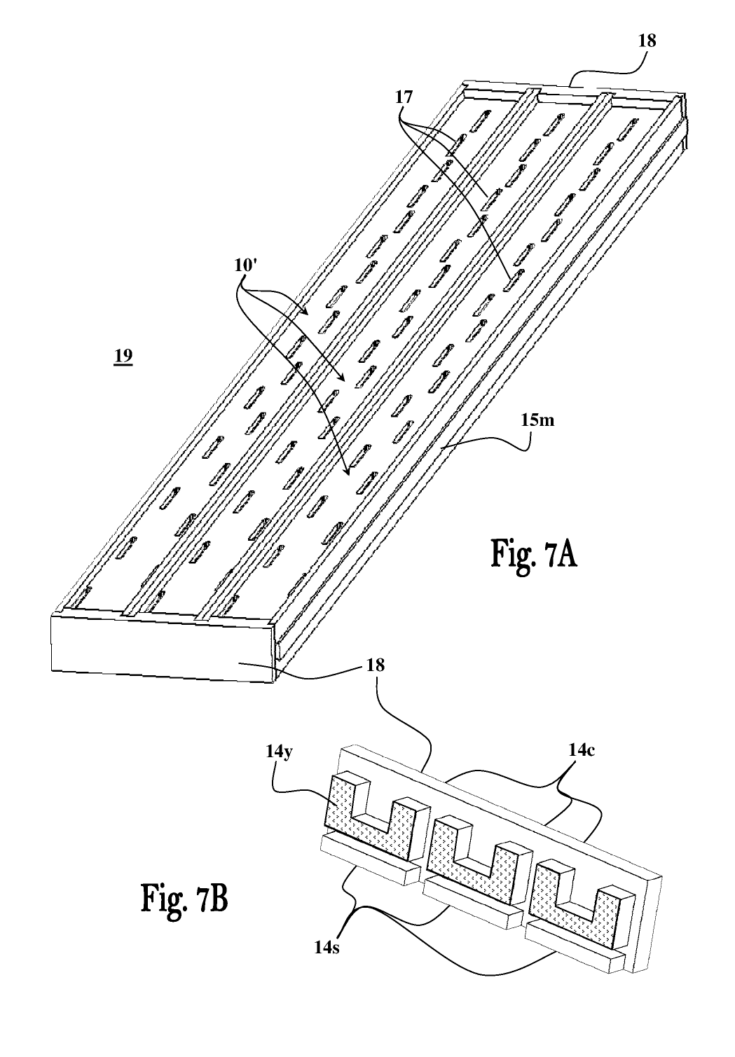

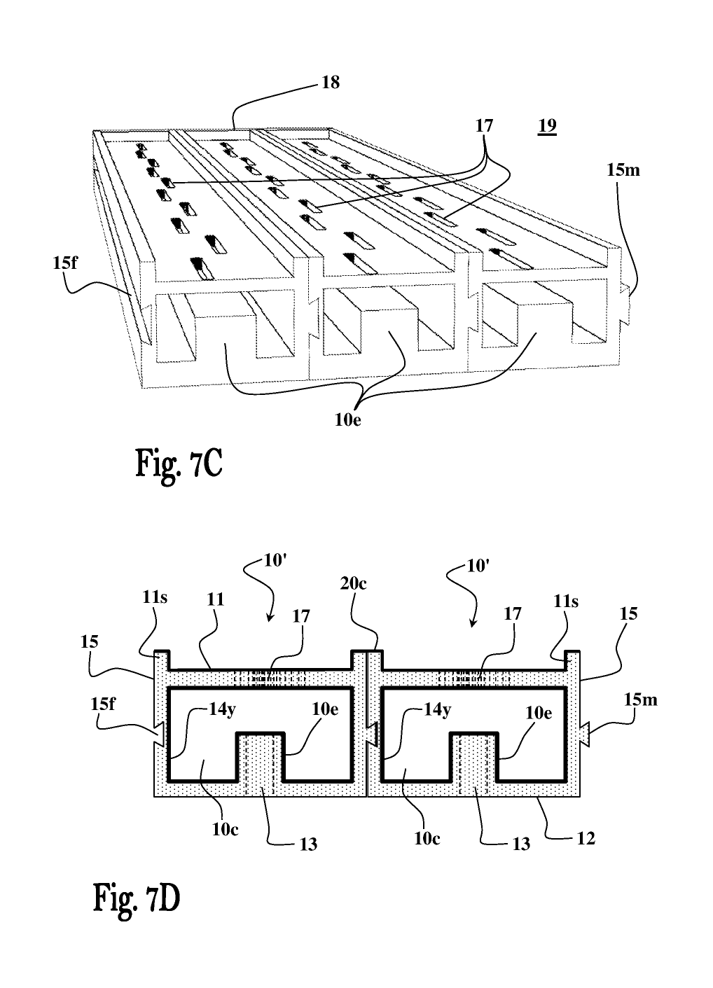

In addition to covering and sealing the end openings 11p, the elongated cover sheets 18 are further used to reinforce the planar array 20 by attaching the extremities of the waveguide elements to rigid supporting covers 18 at both lateral sides of the array 20. In this way, the elongated cover sheets 18 serve as lateral supports to maintain the slotted walls of the waveguide elements substantially aligned at the same plane, and maintain the predetermined distances between the successive waveguide elements required for proper operation of the antenna array 20. Preferably, the planar array 20 structure is further reinforced by applying (e.g., by an autoclaving process) one or more composite material protective payers e.g., radome layers (20c in FIG. 7) over the slotted walls of the waveguide elements 10. The protective layers adhered to the upper sides of the waveguide elements 10 connects the waveguide elements one to the other, and further serve to maintain the predetermined distances between them and the alignment of their slotted upper sides in the same plane.

In FIG. 6 seven slotted waveguide body elements 10 are attached one to the other in a side-by-side configuration, to assemble a planar slotted waveguide antenna. It is noted that such slotted waveguide antenna can comprise any suitable number of slotted waveguide body elements, as required per design considerations. Thus, the array 20 may comprise two or more waveguide body element 10. However, in some possible embodiments a single waveguide body element 10 is used to implement a slotted waveguide antenna.

FIGS. 7A to 7D show waveguide elements 10′ according to possible embodiments comprising mating attachment parts, 15f and 15m, usable for simple and quick construction of waveguide arrays 19. Waveguide elements 10′ are substantially similar to the waveguide elements 10 described hereinabove, and their manufacture techniques are also substantially similar. The main difference is that each waveguide element 10′ comprises a male attachment 15m formed along one lateral side 15 thereof, and a female attachment 15f formed along its other lateral side 15.

In some embodiments the pultrusion die or lamination core used to fabricate the waveguide elements are configured to form the male attachment 15m in one lateral side 15 as an elongated rail laterally protruding from the lateral side 15, and to form the female attachment 15f in the other lateral side 15 of the waveguide elements 10′ as an elongated groove formed therein. This configuration substantially simplifies the attachment of the waveguide elements 10′ in a side-by-side configuration and the assembling of the planar waveguide antenna arrays 19, and guarantees proper attachment of the waveguide elements 10′ in the side-by-side configuration such that the radiator slots are substantially aligned in the same plane of the array 19 and the input and output connectors reside at their respective sides.

The male attachment 15m and it complementary female attachment 15f are configured to attach the waveguide elements one to the other while maintaining their upper slotted sides substantially aligned in the same plane. In addition, the male 15m and female 15f attachments further maintain a predetermined distance between successive waveguide elements, as required for proper operation of the waveguide antenna array 20. As seen in FIG. 7D, in some embodiments the attached waveguide elements 10′ structure is further reinforced by one or more reinforcing layers 20c (e.g., made of fiberglass) applied over the upper sides of the waveguide elements 10′ comprising the radiator slots 17 and the elevated rims 11s.

Referring now to FIG. 7B, in this non-limiting example each of the elongated cover sheets 18 comprises a respective number of fitting protrusions 14c and 14s designed to snugly fit and attach the covers 18 to the end openings 11p of the waveguide elements 10′, as described hereinabove with reference to FIG. 5. This configuration of the elongated cover sheets 18 thus further serve as a reinforcing support that guarantees firm connection between the extremities of the waveguide elements 10′, and that their radiator slots are substantially maintained aligned in the same plane of the waveguide array 19. As shown, in some embodiments, at least the “U”-shaped protrusions 14c of the elongated cover sheets 18 are covered with one or more electrically conducting layers 14y.

In this non-limiting example the cross-sectional shape of the male attachment 15m has a trapezoid cross-sectional shape tapering towards its respective lateral side 15, and the trapezoid cross-sectional shape of the female attachment 15f is substantially complementary as it flares into its respective lateral side 15. Of course, other configurations of the male and female connectors are also possible. FIGS. 7A and 7C exemplify attachment of three waveguide body elements in a side-by-side configuration, and FIG. 7D exemplifies attachment of two waveguide body elements in a side-by-side configuration, but it is clear that this configuration of the waveguide elements 10′ permits a side-by-side attachment of any number of waveguide elements 10′ as per design requirements.

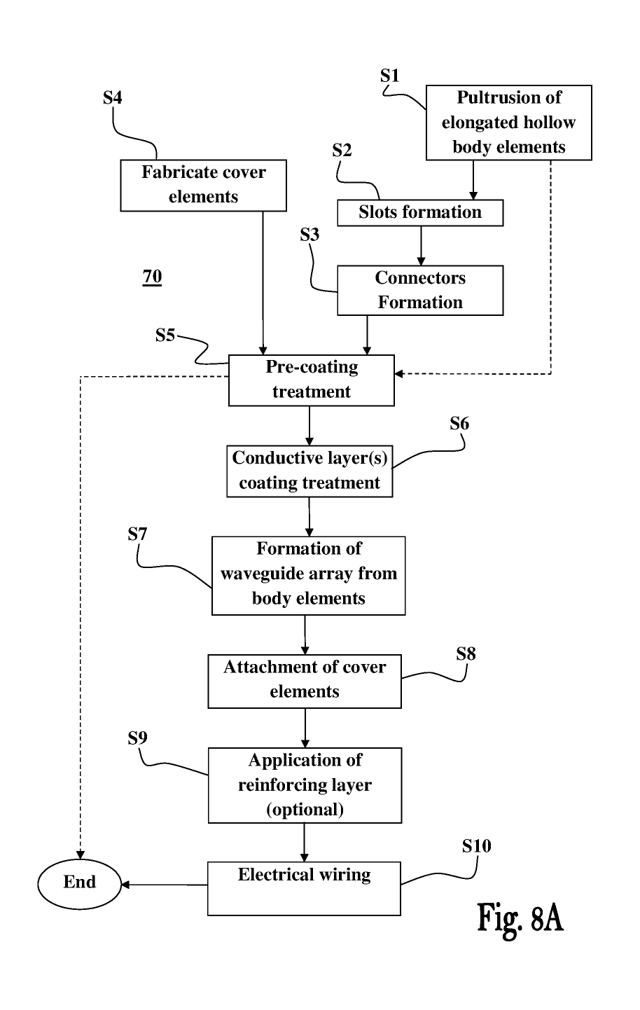

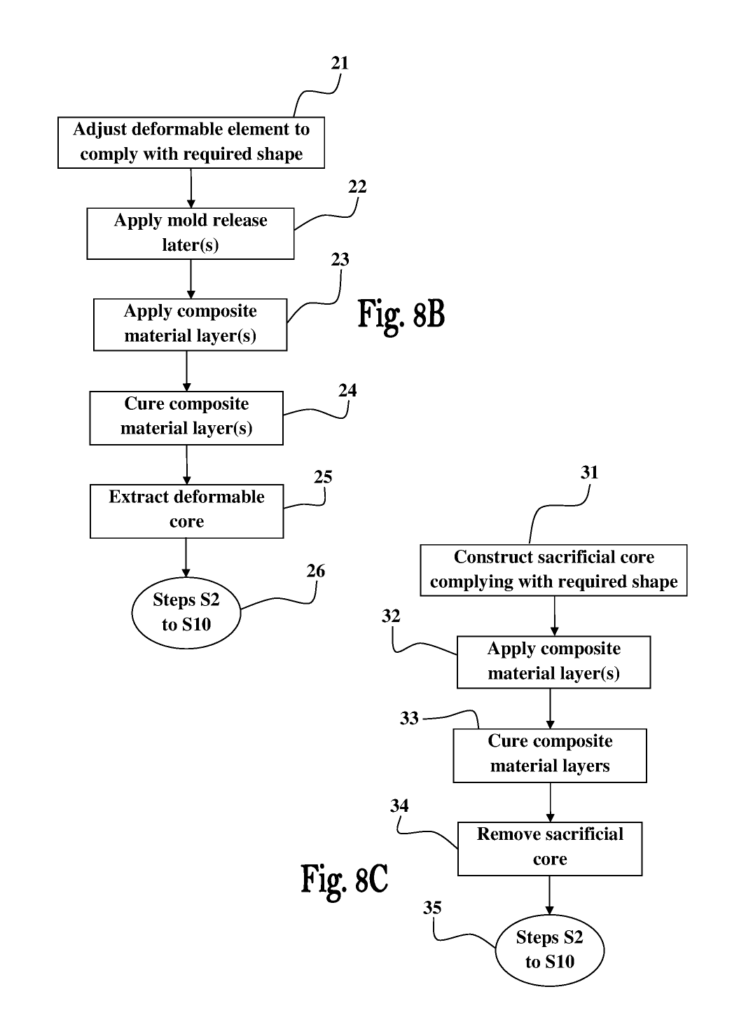

FIG. 8A is a flowchart 70 of a waveguide antenna production process according to some possible embodiments. The process starts in step S1 by manufacturing one or more elongated unitary hollow waveguide body elements (e.g., 10 or 10′) from composite materials by a pultrusion process, as described hereinabove. In steps S2 and S3 the radiation slots (17) are formed on the upper sides of the waveguide body elements, and the connector bores (13) are formed in the bottom face of the elements. The cover elements (14/18) may be fabricated concurrently (or before, or thereafter) in step S4, using any suitable fabrication technique.

The hollow waveguide body elements and their covers are preferably manufactured from a lightweight material, which may have poor electrical conductivity. In this case, in step S5, the waveguide body elements and/or their covers undergo a pre-treatment process for allowing in step S6 application of one or more layers of electrically conducting material(s) over selected surface areas thereof. However, in some embodiments, the one or more electrically conducting layers are applied over the entire surface areas of the waveguide body elements and their covers, and in this case step S5 is not needed and may be skipped.

As indicated by the dashed arrowed lines, if the process is used for fabricating unitary waveguide elements i.e., not for fabrication of antenna elements, then step S2 and S3, of forming the radiator slots and the connector bores, may be skipped, and after applying the one or more electrically conducting layers of the waveguide elements in step S5, the process is ended.

If the an array of waveguide antenna elements is needed, in step S7 two or more waveguide body elements are attached one to the other in the side-by-side configuration as described hereinabove, so as to align the upper slotted sides of the waveguide elements in the same plane and maintain a predetermined distance between successive elements. In step S8 the covers elements are attached over the end openings of the waveguide elements, to substantially seal the end openings and attach the extremities of the waveguide elements one to the other, and thereby reinforce the array structure. In optional step S9 the array structure is further reinforced by applying one or more composite material protective (radome) layers over the slotted upper sides of the waveguide elements. Finally, the waveguide antenna array may be operated after electrically connecting in step S10 its slotted waveguide elements to a transceiver by means of their connector bores.

FIG. 8B is a flowchart of a process for manufacturing unitary hollow waveguide elements by lamination of composite materials over a deformable core (e.g., expandable/inflatable element, such as a smart mandrel). The process starts in step 21 by sculpturing/forming a deformable core into a suitable shape, as needed for the waveguide element. For this purpose various deformable/inflatable tools may be used, such as made from materials that are rigid below the curing temperatures and flexible at higher temperatures (also referred to herein as materials having temperature dependent flexibility properties). In this case, a heated clamshell mold may be used to deform the core into the desired waveguide shape. In case inflatable elements are used in the deformable core, any suitable inflating media (e.g., gas/air or fluid) may be used to inflate/deflate the core. Advantageously, the deformable core element may sculptured/formed to assume round, curved/wavy or flat, surfaces, and any combination thereof, having symmetric or asymmetric cross-sectional shapes.

In step 22 the sculptured/deformed core is coated by one or more mold release layers, and in step 23 one or more composite materials layers are applied over coated core. Thereafter, the composite material layer(s) is cured in step 24, and in step 25 the deformable core is extracted and released from the cured composite material layer(s) covering it by changing it into a retracted/deflated stat, thereby obtaining the cured composite material layer(s) element having the desired waveguide shape.

The deformable core is released according to the specific mechanism used in the manufacture process to sculpture/form the desire waveguide shape. For example, and without being limiting, if inflatable element(s) is used, then the element(s) is deflated, and the core elements is released and then removed from the cured composite layer(s). Alternatively or additionally, if materials having temperature dependent flexibility properties are used in the deformable core, then the temperature of the core may be raised to a temperature greater than the cure temperature, in order to change it from its rigid state into a flexible state and release and remove it from the cured composite layer(s). In case the deformable core comprises a smart (expandable-retractable) mandrel, then the mandrel retraction mechanism is activated in order to change its shape into a retracted slender state allowing its removal from the cured layer(s).

After extracting the deformable core from the cured layer(s), a waveguide element, a waveguide antenna element, or an array antenna of waveguide elements, may be fabricate in step 26 by carrying out steps S2 to S10 of FIG. 8A.

FIG. 8C is a flowchart of a process for manufacturing unitary hollow waveguide elements by lamination of composite materials over a sacrificial core element (e.g., using soluble cores or cores made from phase-changeable materials that can be vaporized or liquefied at raised temperatures). The process starts in step 31 by constructing a sacrificial core element having the required waveguide shape. The construction of the sacrificial core may carry out by a three-dimensional printer, molding (e.g., using a clamshell mold). As will be appreciated by persons skilled in the art, the sacrificial core element may be constructed to assume round, curved/wavy or flat, surfaces, and any combination thereof, having symmetric or asymmetric cross-sectional shapes.

Next, in step 32, one or more composite materials layers are applied over the sacrificial core, and in step 33 the composite material layer(s) is cured. In step 34 the sacrificial core is removed e.g., by dissolving and/or heating the core material and the cured composite material layer element having the desired waveguide shape is extracted. Finally, in step 35, a waveguide element, a waveguide antenna element, or an array antenna of waveguide elements, may be fabricate by carrying out steps S2 to S10 of FIG. 8A.

It should be understood that the steps of the production processes described hereinabove with reference to FIGS. 8A to 8C may be performed in any order (or simultaneously), unless it is clear from the context that one step depends on another being performed first.

As described hereinabove, in some embodiments the elongated cover sheets (18) are plated with one or more electrically conducting layer, which may be attached over the end openings of the waveguide elements by an electrically conducting material. In this case, the elongated cover sheets provide electrical connection between the waveguide elements. In this configuration each waveguide element structure in the array actually has two ports for connecting it to the elements. A first pair of ports is implemented by the elongated male and female connectors, for mating with neighboring similar waveguide element structures at both sides, and the second pair of connecting port(s), which is common for the array of the waveguide structures, is implemented by the end openings of the waveguide elements and used for connection between the elements by means of the elongated cover sheets. In some embodiments, the connecting ports are integral in each waveguide structure produced by pultrusion.

As described hereinabove and shown in the associated figures, the present invention provides low-weight monolithic (i.e., made from one continuous piece of material) waveguide configurations, and related manufacture techniques, particularly suitable for construction of waveguide array antennas. The low weight and low production costs of the waveguide structure array, and the ability to manufacture them by mass production, are favorable for use in the manufacture of small and lightweight portable radar antennas that can be carried by a user in a backpack manner

While particular embodiments of the invention have been described, it will be understood, however, that the invention is not limited thereto, since modifications may be made by those skilled in the art, particularly in light of the foregoing teachings. As will be appreciated by the skilled person, the invention can be carried out in a great variety of ways, employing more than one technique from those described above, all without exceeding the scope of the invention.

1. A waveguide comprising an elongated hollow element having an elongated internal cavity and one or more electrically conducting layers plating at least internal walls of said elongated cavity, said elongated hollow element being a continuous unitary element made from a fibrous material impregnated with a resin material and comprising two pass-through connector bores each formed in a face of the elongated hollow element and configured for electromagnetic coupling with the waveguide, thereby providing a lightweight unitary waveguide structure that substantially minimize or preclude leakage of electromagnetic energy along its length.

2. The waveguide of claim 1 wherein the two pass-through connector bores are formed in a back face of the elongated hollow element and located at a respective end portion thereof.

3. The waveguide of claim 1 wherein the elongated hollow element comprises a plurality of radiator slots distributed along a front face thereof.

4. The waveguide of claim 2 comprising two cover elements respectively attached over end openings of the elongated hollow element, each cover element comprising one or more layers of electrically conducting material plated over at least a surface area thereof covering a respective end opening of the elongated hollow element.

5. The waveguide of claim 3 wherein lateral side faces of the elongated hollow element comprise connector elements, each connector element being configured to mate with a connector element of an elongated hollow element of another waveguide and thereby enable successively connecting two or more waveguides one parallel to the other, while maintaining a predetermined distance between them and substantially aligning the radiator slots in their front faces in the same plane.

6. The waveguide of claim 5 wherein the connector elements comprise an elongated male connector provided on one lateral side face of the elongated hollow element and a complementary elongated female connector element provided on its other lateral side face.

7. The waveguide of claim 6 wherein the elongated male connector element has a tapering configuration and the elongated female connector has a complementary flaring configuration.

8. The waveguide of claim 3 comprising an elevated rim formed about the front face of the elongated hollow element thereby forming a cavity in which the radiator slots are located.

9. The waveguide of claim 1 comprising an elongated rib formed on a bottom internal wall of the elongated hollow element.

10. The waveguide of claim 3 wherein the radiator slots are distributed along the front face of the elongated hollow element forming a “>”-shaped pattern.

11. The waveguide of claim 1 wherein the elongated hollow element is manufactured by pulling fibrous material through a heated curing die configured to impregnate the pulled fibrous material with a suitable resin.

12. The waveguide of claim 1 wherein the elongated hollow element is manufactured by layering one or more composite material layers over a deformable or a sacrificial core element, said core element having substantially flat or curved surface areas, or combinations thereof.

13. A waveguide array comprising two or more of the waveguides of claim 4 successively attached to each other at their lateral sides.

14. The waveguide array of claim 13 wherein the covering elements are two elongated elements each configured to cover end openings at lateral sides of the waveguide array and substantially attach and align the extremities of the two or more waveguides of the array.

15. The waveguide array of claim 13 comprising one or more reinforcing layers applied over the front faces of the waveguide array.

16. The waveguide array of claim 15 wherein the one or more reinforcing layers are protective layers configured to form a radome over a radiator plane of the array.

17. A waveguide antenna comprising:
an array of two or more elongated hollow elements attached one to the other in a side-by-side configuration, each elongated hollow element being a continuous unitary element made from a composite material and having an elongated internal cavity, said elongated hollow element comprising: one or more electrically conducting layers plated over at least internal walls of said elongated internal cavity; a plurality of pass-through slots distributed along a front face thereof; and two pass-through connector bores, located at a respective end portion of said element and configured for electromagnetic coupling therewith; and
two elongated cover elements each attached over one lateral side of the array for substantially closing end openings of the two or more elongated hollow element of the array, said cover elements configured to substantially attach extremities of said two or more elongated hollow elements one to the other.

18. The waveguide antenna of claim 17 wherein lateral side faces of the elongated hollow elements comprise connector elements, each connector element being configured to mate and connect with a connector element of a successive elongated hollow element in the array, maintain a predetermined distance therebetween, and substantially align the pass-through slots in the front faces of the elongated hollow element in the same plane.

19. The waveguide antenna of claim 17 comprising one or more reinforcing layers applied over the front faces of the two or more elongated hollow elements and configured to attach said elongated hollow elements to each other and maintain a predetermined distance between them.

20. A waveguide production process comprising:
forming an elongated continuous unitary hollow element from a fibrous material by impregnating said fibrous material with a resin material and forming a predetermined waveguide shape therefrom;
plating at least inner walls of said elongated hollow element by electrically conducting material; and
forming in end portions of a bottom face of said elongated hollow element two pass-through connector bores,
thereby obtaining a lightweight unitary waveguide structure that substantially minimize or preclude electromagnetic energy leakage along its length.

21. The production process of claim 20 wherein the forming of the predetermined waveguide shape comprises pulling the fibrous material through a heated curing die configured to impregnate the pulled fibrous material with the resin material.

22. The production process of claim 20 wherein the forming of the predetermined waveguide shape comprises: shaping a deformable core element in accordance with the predetermined shape of the waveguide, applying one or more layers of the fibrous and resin materials over the deformable core element, curing the one or more layers applied over the core element, and deforming the core element and extracting the one or more cured layers therefrom.

23. The production process of claim 22 wherein the shaping of the deformable core comprises heating the core elements to change said core element into a softened state, molding said core element to provide the predetermined waveguide shape, and cooling the core element to change said core element into a rigid state.

24. The production process of claim 20 wherein the forming of the predetermined waveguide shape comprises: preparing a sacrificial core element in accordance with the predetermined shape of the waveguide; applying one or more layers of the fibrous and resin materials over the deformable core element, curing the one or more layers applied over the core element, and removing the sacrificial core element from the one or more cured layers.

25. The production process of claim 24 wherein the removing of the sacrificial core element comprises at least one of vaporizing, liquefying, and dissolving, said core element.

26. The production process of claim 22 wherein the core element is-comprises substantially flat or curved surface areas, or combinations thereof.

27 (canceled)

28. The production process of claim 20 comprising forming a plurality of pass-through slots along a front face of the elongated hollow element.

29. The production process of claim 28 comprising forming cover elements and closing end openings of the elongated hollow element by said cover elements.

30. The production process of claim 29 comprising applying one or more electrically conducting layers over surface areas of the cover elements.

31. The production process of claim 28 comprising forming connector elements in lateral sides of the elongated hollow element, each connector element being configured to mate with a connector element of an elongated hollow element of another waveguide and thereby enable successively connecting two or more of the waveguides one parallel to the other, while maintaining a predetermined distance between them and substantially aligning their front faces in the same plane.

32. A process of fabricating a waveguide antenna comprising: producing two or more of the waveguides according to claim 28 and attaching them one to the other in parallel to form a planar array, wherein the cover elements are elongated elements and the closing of the end openings comprises attaching one cover element over each lateral side of the array for closing the end openings therein and attaching the extremities thereof

33. The process of claim 32 comprising applying one or more reinforcing layers over the front faces of the elongated hollow elements to thereby attach them to each other and maintain a predetermined distance between them.
